(19) United States
(12) Patent Application Publication
(10) Pub. No.: US 2026/0370148 A1
(43) Pub. Date: Nov. 19, 2026

(54) POWER CONVERSION APPARATUS AND POWER CONVERSION METHOD

(71) Applicant: Delta Electronics (Shanghai) CO., LTD., Shanghai (CN)

(72) Inventors: Hong LIU, Shanghai (CN); Yuxin HAN, Shanghai (CN); Wenfei HU, Shanghai (CN); Baihui SONG, Shanghai (CN); Wen ZHANG, Shanghai (CN)

(73) Assignee: Delta Electronics (Shanghai) CO., LTD., Shanghai (CN)

(21) Appl. No.: 19/674,267

(22) Filed: May 12, 2026

(30) Foreign Application Priority Data
May 13, 2025 (CN) 2025106165627

(51) Int. Cl. H02M 3/335; H02M 1/08; H02M 3/00; H02M 3/26; H02M 7/797

(52) U.S. Cl. CPC H02M 3/33573; H02M 1/08; H02M 3/01; H02M 3/26; H02M 3/33571; H02M 3/33584; H02M 3/33592; H02M 7/797

(57) ABSTRACT

A power conversion apparatus includes: a first circuit, including a first switch bridge arm and a second switch bridge arm, where the first switch bridge arm includes a first switch and a second switch connected in series, and the second switch bridge arm includes a third switch and a fourth switch connected in series; the first switch and the second switch are electrically connected to form a first connection point; the third switch and the fourth switch are electrically connected to form a second connection point; a network circuit, where a first end of a first side of the network unit is electrically connected to the first connection point, and a second end of the first side of the network unit is electrically connected to the second connection point.

### CROSS REFERENCE

This application claims priority to Chinese Patent Application No. 2025106165627, filed on May 13, 2025, the entire contents of which are incorporated herein by reference.

### TECHNICAL FIELD

The present disclosure relates to the field of power electronics technology, particularly to a power conversion apparatus and a power conversion method.

### BACKGROUND

The Solid State Transformer (SST) is a new type of transformer based on power electronics technology. The SST utilizes high-frequency link technology and advanced control algorithms to achieve voltage and current transformation.

In current practical power consumption systems, many application scenarios requiring wide-range output of DC power sources, such as photovoltaic cells, power batteries, energy storage batteries, and electrochemical power sources. For instance, the production process of electrolytic aluminum foil includes multiple chemical reaction tanks, and the different voltage levels of each reaction tank are different.

Although SST has demonstrated many advantages, further technological improvements are still required to better meet the wide-range voltage requirements of loads in the application fields above-mentioned.

### SUMMARY

A power conversion apparatus and a power conversion method are provided in the present disclosure.

Other features and advantages of the present disclosure will become apparent from the following detailed description or be acquired, at least in part, through the practice of the present disclosure.

According to one aspect of the present disclosure, a power conversion apparatus is provided, including:
a first circuit unit, including a first switch bridge arm and a second switch bridge arm, where the first switch bridge arm includes a first switch and a second switch connected in series, and the second switch bridge arm includes a third switch and a fourth switch connected in series; the first switch and the second switch are electrically connected to form a first connection point; the third switch and the fourth switch are electrically connected to form a second connection point, the first switch and the second switch are complementary switches, and the third switch and the fourth switch are complementary switches;
a network unit, including at least a first capacitor, where a first end of a first side of the network unit is electrically connected to the first connection point, and a second end of the first side of the network unit is electrically connected to the second connection point; and
a control unit, simultaneously connected to the first switch bridge arm and the second switch bridge arm, where the control unit is used to output a first control signal to a control terminal of the first switch, and output a fourth control signal to a control terminal of the fourth switch;
where, a time difference between a rising edge of the first control signal and a rising edge of the fourth control signal is T1, a time difference between a falling edge of the first control signal and a falling edge of the fourth control signal is T2, where a following condition is satisfied: T1≠T2, T1 is greater than or equal to 0, and T2 is greater than or equal to 0.

According to another aspect of the present disclosure, a method for controlling a power conversion apparatus is provided, where the control method is applied to the power conversion apparatus above and includes:
outputting the first control signal to the control terminal of the first switch, and outputting the fourth control signal to the control terminal of the fourth switch;
where the time difference between the rising edge of the first control signal and the rising edge of the fourth control signal is T1, and the time difference between the falling edge of the first control signal and the falling edge of the fourth control signal is T2, and a following condition is satisfied: T1≠T2, and T1 is greater than or equal to 0.

It should be understood that the above general description and the detailed description below are merely exemplary and explanatory, and the present disclosure not can be limited.

### BRIEF DESCRIPTION OF THE DRAWINGS

The attached drawings herein are incorporated into the specification and form a part thereof, illustrating embodiments in accordance with the present disclosure and, together with the specification, are used to explain the principles of the present disclosure.

It should be noted that the attached drawings described below are merely some embodiments of the present disclosure. For a person skilled in the art, other drawings can be obtained without creative labor based on these attached drawings.

FIG. 1 shows a diagram of the architecture of a power conversion apparatus in an embodiment of the present disclosure.

FIG. 2 and FIG. 3 show circuit diagrams of the first circuit unit and the network unit in an embodiment of the present disclosure.

FIG. 4 shows a diagram of the architecture of a power conversion apparatus in an embodiment of the present disclosure;

FIG. 5 and FIG. 6 show circuit diagrams of the first circuit unit, the network unit and the second circuit unit in an embodiment of the present disclosure;

FIG. 7 shows a waveform diagram in an embodiment of the present disclosure;

FIG. 8 shows a simulation result diagram in an embodiment of the present disclosure;

FIG. 9 shows a state trajectory diagram in an embodiment of the present disclosure;

FIG. 10 shows a ZVS analysis simulation result diagram when Da is small in an embodiment of the present disclosure;

FIG. 11 shows a control logic diagram in an embodiment of the present disclosure;

FIG. 12 shows a diagram of the first control signal leading or lagging the fourth control signal in an embodiment of the present disclosure;

FIG. 13 shows an alternating duty cycle drive waveform diagram in an embodiment of the present disclosure;

FIG. 14 shows another control logic diagram in an embodiment of the present disclosure;

FIG. 15 shows a wide-range step-down method diagram under different gains in an embodiment of the present disclosure;

FIG. 16 shows a full-bridge to half-bridge switching simulation result diagram in an embodiment of the present disclosure;

FIG. 17 shows a mode diagram under different time periods during full-bridge to half-bridge switching in an embodiment of the present disclosure;

FIG. 18 shows a diagram of different alternating periods in an embodiment of the present disclosure;

FIG. 19 shows a half-bridge step-down simulation result diagram in an embodiment of the present disclosure;

FIG. 20 shows a switching frequency control simulation result diagram in an embodiment of the present disclosure;

FIG. 21 shows a simulation result diagram when T1>T2 in an embodiment of the present disclosure;

FIG. 22 shows a circuit diagram of the first circuit unit, the network unit and the second circuit unit in an embodiment of the present disclosure;

FIG. 23 shows a circuit diagram of the first circuit unit, the network unit and the second circuit unit in an embodiment of the present disclosure;

FIG. 24 shows a single-stage system topology diagram in an embodiment of the present disclosure;

FIG. 25-FIG. 26 show circuit diagrams of the first circuit unit in an embodiment of the present disclosure;

FIG. 27-FIG. 31 show circuit diagrams of the network unit in an embodiment of the present disclosure;

FIG. 32-FIG. 34 show circuit diagrams of the second circuit unit in an embodiment of the present disclosure.

### DETAILED DESCRIPTION

To make the objectives, technical solutions and advantages of the embodiments of the present disclosure clearer, the technical solutions of the embodiments of the present disclosure will be described clearly and completely in conjunction with the accompanying drawings of the embodiments of the present disclosure.

The following is a detailed description of the exemplary embodiments in conjunction with the accompanying drawings and the embodiments.

It should be clarified herein that, throughout the disclosure, descriptions limiting the quantity of components—such as “first,” “second,” etc. (e.g., “first circuit unit,” “first switch,” “first capacitor”)—do not constitute limitations regarding the connection sequence of the components or any other sequence that might lead to misunderstanding. Instead, they serve solely to distinguish between different components. In fact, such descriptions as “first,” “second,” “third,” etc., impose no limitations whatsoever on the sequence of the components or on any other sequence that might give rise to misunderstanding.

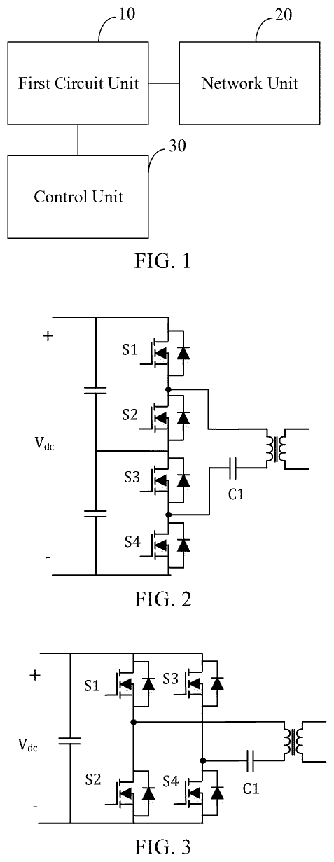

FIG. 1 shows a power conversion apparatus provided by an embodiment of the present disclosure. The power conversion apparatus includes a first circuit unit 10, a network unit 20 and a control unit 30. The control unit 30 is mainly used to control the first circuit unit 10. The forms of the circuit diagram corresponding to the power conversion apparatus are various. As an example, the circuit diagrams corresponding to the first circuit unit 10 and the network unit 20 can be as shown in FIG. 2 or FIG. 3. It should be understood that FIGS. 2 and 3 are only one embodiment of the present disclosure, and the power conversion apparatus of the present disclosure may further be in other forms.

As shown in FIG. 2, the first circuit unit 10 includes a first switch bridge arm and a second switch bridge arm, where the first switch bridge arm includes a first switch S1 and a second switch S2 connected in series, and the second switch bridge arm includes a third switch S3 and a fourth switch S4 connected in series. The first switch S1 and the second switch S2 are electrically connected to form a first connection point. The third switch S3 and the fourth switch S4 are electrically connected to form a second connection point, where the first switch S1 and the second switch S2 are complementary switches, and the third switch S3 and the fourth switch S4 are complementary switches. It should be noted that the two complementary switches will not be in the conducting state at the same time at any moment. When one switch of the two complementary switches is turned on, the other is turned off, and vice versa. It should be understood that a dead time occurs during the state transition of complementary switches. Both switches are in the off state during the dead time. For example, the first switch S1 and the second switch S2 are complementary switches. The meaning of complementary is that when S1 is turned on, S2 is turned off; when S1 is turned off, S2 is turned on. A dead time occurs between the switching states of S1 and S2.

The above-mentioned first switch bridge arm and the second switch bridge arm may be connected in series or in parallel. As shown in FIG. 2, the second switch is connected to the third switch, so that the first switch bridge arm and the second switch bridge arm are connected in series. As shown in FIG. 3, the first switch is connected to the third switch, and the second switch is connected to the fourth switch, so that the first switch bridge arm and the second switch bridge arm are connected in parallel.

The network unit 20 includes at least a first capacitor C1. The first end of the first side of the network unit 20 is electrically connected to the first connection point, and the second end of the first side of the network unit 20 is electrically connected to the second connection point. In the example shown in FIG. 1, the first side of the network unit 20 is the left side in the FIG. 1, and the first end of the first side is the upper connection line in the FIG. 1.

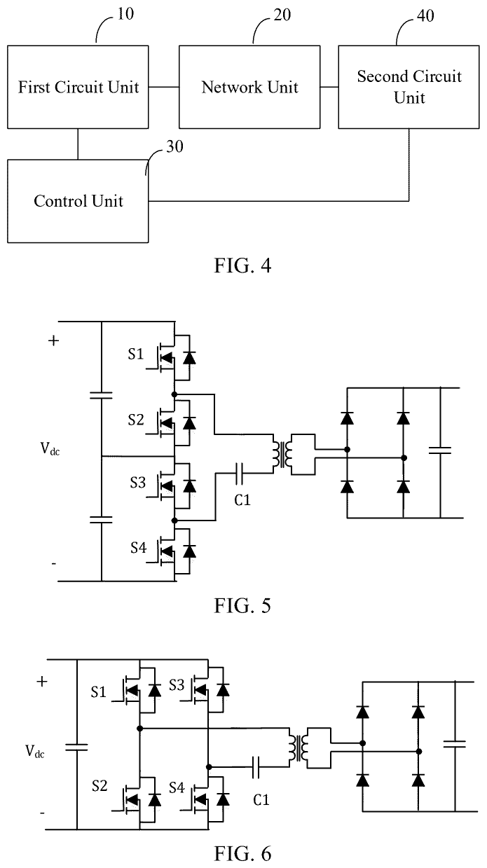

In some embodiments, as shown in FIG. 4, the power conversion apparatus may further include a second circuit unit 40, and the second circuit unit 40 may be a rectifier circuit. As an example, the circuit diagrams corresponding to the first circuit unit 10, the network unit 20 and the second circuit unit 40 can be as shown in FIG. 5 or FIG. 6. It should be understood that FIG. 5 and FIG. 6 are only one embodiment of the present disclosure, and the power conversion apparatus of the present disclosure may further be in other forms.

The control unit 30 is introduced as following.

The control unit 30 is simultaneously connected to the first switch bridge arm and the second switch bridge arm. The control unit 30 is used to output a first control signal Gs1 to the control terminal of the first switch S1 and output a fourth control signal Gs4 to the control terminal of the fourth switch S4; where the time difference between the rising edge of the first control signal Gs1 and the rising edge of the fourth control signal Gs4 is T1, and the time difference between the falling edge of the first control signal Gs1 and the falling edge of the fourth control signal Gs4 is T2, where a following condition is satisfied: T1≠T2, T1 is greater than or equal to 0, and T2 is greater than or equal to 0.

In some embodiments, the control unit 30 is further used to output a second control signal Gs2 to the control terminal of the second switch S2 and output a third control signal Gs3 to the control terminal of the third switch S3.

The time difference between the rising edge of the second control signal Gs2 and the rising edge of the third control signal Gs3 is T3, and the time difference between the falling edge of the second control signal Gs2 and the falling edge of the third control signal Gs3 is T4, where a following condition is satisfied: T3≠T4, T3 is greater than or equal to 0, and T4 is greater than or equal to 0.

It can be understood that the values of T1 and T3 are the same, and the values of T2 and T4 are the same in the embodiments of the present disclosure. The adjustment of T1 in the following text can be understood as the adjustment of T3, and the adjustment of T2 can be understood as the adjustment of T4.

In some embodiments, the turn-on time difference T1 (T3) is greater than the turn-off time difference T2 (T4). In some embodiments, the turn-on time difference T1 (T3) is less than the turn-off time difference T2 (T4). The turn-on time difference T1 (T3) is greater than the turn-off time difference T2 (T4) as an example for illustration in the following text.

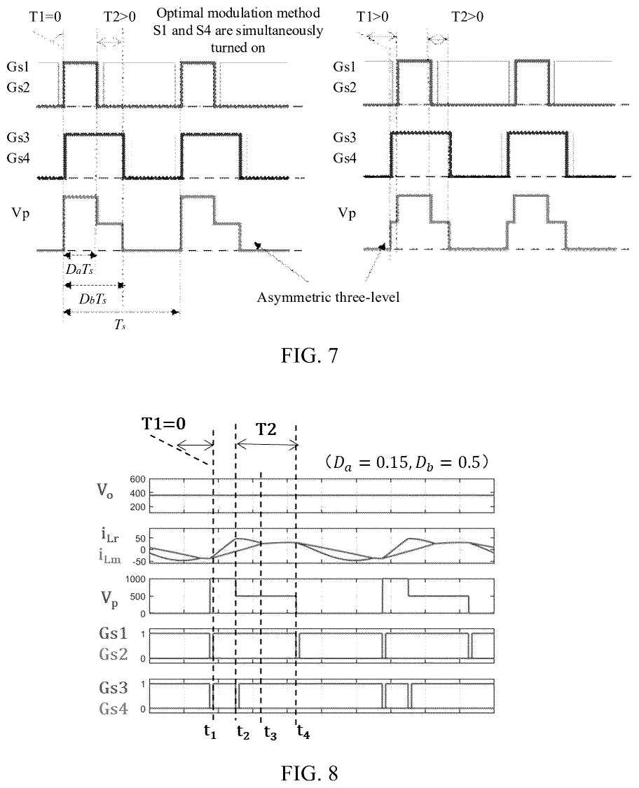

The left side of FIG. 7 shows a preferred modulation method for the circuit described above-mentioned. The drive waveforms and port voltage Vp in the cases of T1=0 and T1>0 are shown in the left side of FIG. 7. The drive waveforms Gs1 and Gs4 are asymmetric, and the port voltage is asymmetric three-level.

In some cases, the above modulation method may cause the switch tube to lose ZVS (Zero Voltage Switching, zero-voltage switching). Accordingly, the ZVS of the switch tube can be achieved by adjusting the rising edge time difference (T1>0, T2>0, and T1<T2), as shown in the right side of FIG. 7. In other words, the drive waveform of Gs1 is to be fine-tuned, and the range of T1 for achieving ZVS is given by Equation (1).

(1/4-Da₁)Ts₁<T1<Ts₁/4 (1)

Where Ts₁ represents the switching period of the first control signal Gs1, and Da₁ represents the adjustable duty cycle of the first control signal. The port voltage remains asymmetric three-level.

In some embodiments, the time difference T3 between the rising edge of the second control signal Gs2 and the rising edge of the third control signal Gs3 satisfies the Equation (2).

(1/4−Da₃)Ts₃<T3<Ts₃/4 (2)
where Ts₃ represents the switching period of the third control signal, and Da₃ represents the adjustable duty cycle of the third control signal.

It should be noted that Da₁ and Da₃ are the same, and Da₁ and Da₃ are represented by Da in FIG. 4a. Db represents the reference duty cycle, and Ts represents the switching period.

In some embodiments, the control unit 30 is further used to perform gain adjustment over a wide range by regulating the time difference T2 between the falling edge of the first control signal Gs1 and the falling edge of the fourth control signal Gs4.

In some embodiments, the control unit 30 is further used to perform gain adjustment over a wide range by regulating a time difference T4 between a falling edge of the second control signal Gs2 and a falling edge of the third control signal Gs3.

In the embodiments of the present disclosure, T1 and T2 may be regulated separately to achieve ZVS and a wide gain range. Where at least one lagging switch (S2 or S3) can be achieved to ZVS by adjusting the turn-on time difference T1. A gain adjustment over a wide range can be achieved by regulating the turn-off time difference T2 (for example, through the adjustable duty cycle Da and the reference duty cycle Db). In other words, the turn-on time difference and the turn-off time difference between Gs1 and Gs4 are decoupled, and the turn-on time difference and the turn-off time difference are regulated to be used for maintaining ZVS and meeting the gain requirements respectively.

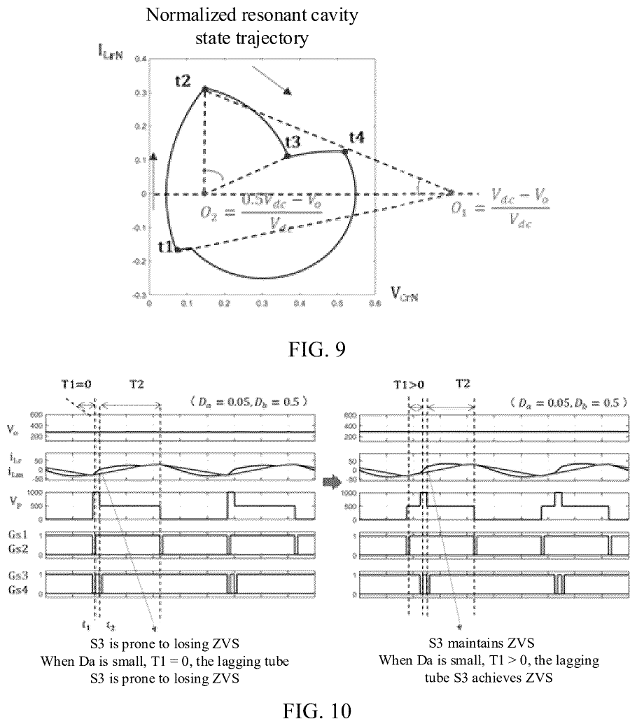

FIG. 8 shows the simulation results of the embodiments of the present disclosure, and FIG. 9 shows the state trajectory. Referring to FIG. 8 and FIG. 9, during the t1~t2 period, at the t1 moment, i_{Lr}<0, S1 and S4 are turned on by ZVS, the voltage across the resonant cavity is equal to V_{dc}−Vₒ, and i_{Lr} changes rapidly (increases). During the t2~t3 period, at the t2 moment, i_{Lr}>0, S4 is turned off and S3 is turned on by ZVS, and the voltage across the resonant tank is 0.5 V_{dc}−Vₒ, with i_{Lr} decreasing. During the t3~t4 period, i_{Lr}=i_{Lm} and i_{Lr} gradually increases, and the secondary side enters discontinuous mode. At the t4 moment, i_{Lr}=i_{Lm}>0, S1 is turned off and S2 is turned on by ZVS. According to the above mode changes, it can be known that when Da is large, T1=0, and ZVS can be achieved over a wide range.

Under certain conditions, ZVS may be lost, as shown in the left picture of FIG. 10. When Gs4 is turned on, the current i_{Lr} has not risen to meet the ZVS turn-on condition. Therefore, the magnitude of T1 may be appropriately regulated, in other words, the phase of Gs4 can be delayed, so that all switch tubes can meet ZVS, as shown in the right picture of FIG. 10, causing the ZVS can be achieved by lagging switch and the ZVS range is wider.

The estimation condition of ZVS is shown in Equation (3).

$$\{ \begin{matrix}\frac{{T}_{{S}_{1}}}{4} - {D}_{{a}_{1}} {T}_{{S}_{1}} - \frac{{L}_{m}}{{nV}_{0}} ρ sin ( 2 π {D}_{{a}_{1}} ) < T 1 < \frac{{T}_{{S}_{1}}}{4} \\ T 2 = {D}_{b} {T}_{{S}_{1}} - T 1 - {D}_{{a}_{1}} {T}_{{S}_{1}}\end{matrix} \qquad ( 3 )$$

where,

$${f}_{s} \approx {f}_{r} , {D}_{b} \approx 0.5 ,$$

$$ρ \approx \frac{1}{2} - \frac{{nV}_{0}}{{V}_{i n}} + \frac{1}{4 {V}_{i n}} \sqrt{\frac{{L}_{r}}{{C}_{r}}} \cdot \sqrt{\frac{{n}^{2} {V}_{o}^{2} {T}_{{s}_{1}}^{2}}{{L}_{m}^{2}} + 4 {{π}^{2} ( \frac{{I}_{o}}{n} )}^{2}} ,$$

and Equation (3) can further be simplified to be Equation (1) in the previous text. Similarly, Equation (2) in the previous text can be obtained.

In some embodiments, the control unit 30 may further include an enable control module. The enable control module outputs an enable control signal to the duty cycle control module. The control unit 30 switches the first circuit unit 10 from full-bridge operation mode to half-bridge operation mode based on the enable control signal.

It can be understood that in the full-bridge operation mode, the switch tubes on the same bridge arm are complementary turned on or off, in other words, the first switch (S1) and the second switch (S2) are complementary switches, and the third switch (S3) and the fourth switch (S4) are complementary switches. In the same switching period, each of the four switches is turned on or off once. In the half-bridge operation mode, the switch tubes on the same bridge arm are complementary turned on or off, in other words, the first switch (S1) and the second switch (S2) are complementary switches, and the third switch (S3) and the fourth switch (S4) are complementary switches. In the same switching period, the two switch tubes on one bridge arm remain constantly on or off (for example, the first switch S1 is constantly turned on, and the second switch S2 is constantly turned off), and the two switch tubes on the other bridge arm are turned on or off once each.

In some embodiments, the control unit 30 may also include a switching frequency control module. The switching frequency control module is used to generate a switching frequency signal. The control unit 30 generates the first control signal and the fourth control signal based on the switching frequency signal. The control unit 30 further adjusts the switching frequency signal to regulate the gain of the power conversion apparatus.

In some embodiments, if Da is small, the voltage can be reduced by other methods, such as frequency modulation, and methods such as limiting can be used to avoid a small duty cycle Da.

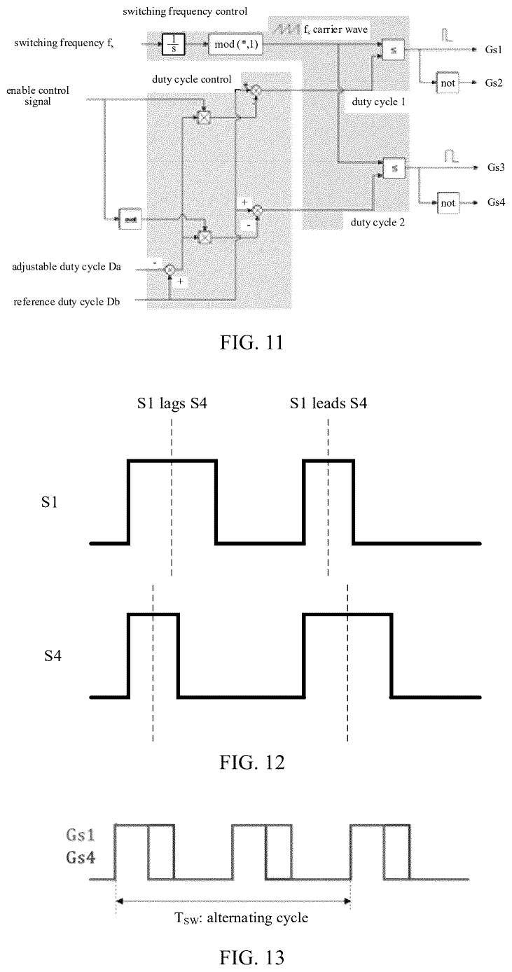

During the control process, the adjustable duty cycle (Da), reference duty cycle (Db), and switching frequency (fs) are regulated, and the control logic is shown in FIG. 11. The FIG. 11 includes a duty cycle control module and a frequency control module. Since Gs1 and Gs4 are symmetrical working switch tubes, the bridge arm can be modulated with an adjustable duty cycle or a reference duty cycle determined by the enable control signal. The present embodiment achieves a wide output voltage gain range by changing the fundamental size of the port voltage (resonant cavity input voltage). The control logic is simple causing a continuous and smooth voltage transformation process.

In some embodiments, the control unit 30 controls alternate operation between a first operation mode and a second operation mode of the power conversion apparatus through the first control signal Gs1 and the fourth control signal Gs4; where the first control signal Gs1 leads the fourth control signal Gs4 in the first operation mode, and the first control signal Gs1 lags the fourth control signal Gs4 in the second operation mode. As shown in FIG. 11, the first control signal Gs1 leads the fourth control signal Gs4, indicating that the midpoint between the rising edge and the falling edge of the Gs1 drive signal leads the midpoint between the rising edge and the falling edge of the Gs4 drive signal. Similarly, as shown in FIG. 12, the first control signal Gs1 lags the fourth control signal Gs4, indicating that the midpoint between the rising edge and the falling edge of the Gs1 drive signal lags the midpoint between the rising edge and the falling edge of the Gs4 drive signal. It should be noted that in the present embodiment, the first operation mode and the second operation mode alternately operate, where the alternation may be every N cycles, with N greater than or equal to 1, or not every N cycles. In other words, the first operation mode and the second operation mode in the present embodiment is only be to alternately operate, and does not be to alternate at a fixed period.

In some embodiments, the control unit 30 controls alternate operation between a third operation mode and a fourth operation mode of the power conversion apparatus through the first control signal Gs1 and the fourth control signal Gs4; where the third operation mode is a duty cycle of the first control signal Gs1 is 0 and a duty cycle of the fourth control signal Gs4 is not 0, and the fourth operation mode is a duty cycle of the first control signal Gs1 is not 0 and a duty cycle of the fourth control signal Gs4 is 0. The alternation of the third operation mode and the fourth operation mode is similar to the alternation of the first operation mode and the second operation mode described above, and will not be elaborated here.

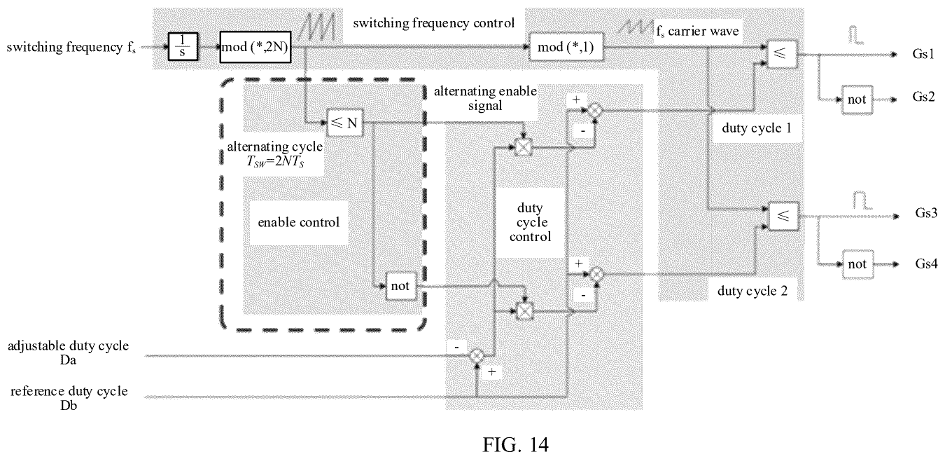

FIG. 13 shows the drive waveforms of the alternating duty cycle control in the present embodiment. Since the circuits in FIG. 2 and FIG. 5 are to maintain equal input capacitor voltages, midpoint balance, during operation, the upper and lower bridge arms are to alternate operation. The control logic of the method, based on FIG. 13, an alternating enable control module is added, so that making the upper and lower bridge arms alternately operate in two modulation modes. The two modulation modes are adjustable duty cycle and reference duty cycle. The control logic is shown in FIG. 14.

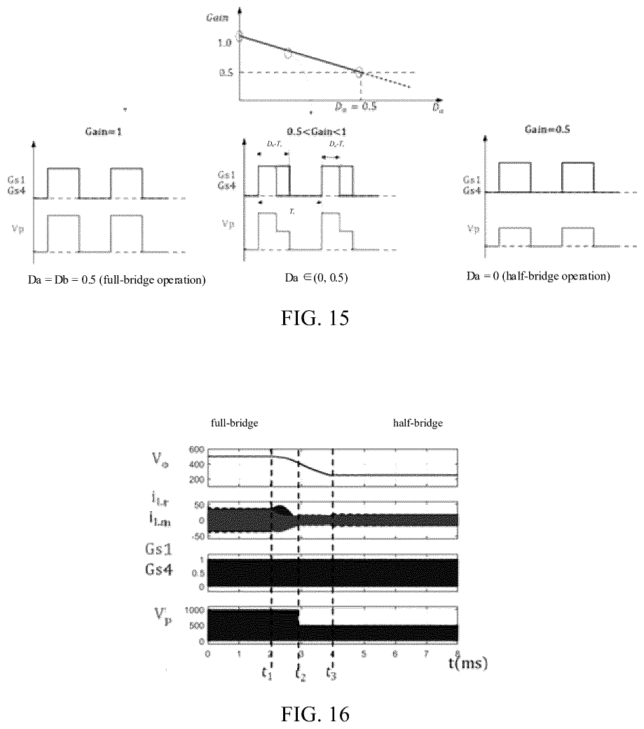

FIG. 15 illustrates the wide-range step-down method of the present embodiment at different gains (fs=fr, Db=0.5): when the gain is equal to 1, Gs1 and Gs4 operate in synchronous switching; within the range where the gain is less than 1 and greater than 0.5, the output gain can be gradually reduced by gradually reducing the adjustable duty cycle; when the gain is 0.5, the adjustable duty cycle is 0, the SHB will operate in an alternating half-bridge state.

The above process is also the switching process from full-bridge operation to half-bridge operation, and simulation results of the switching process are shown in FIG. 16. The above process controls the adjustable duty cycle Da to gradually decrease (0.5≤Gain≤1, fs=fr, Db=0.5). As can be seen from the results, the switching process mainly consists of four modes, as shown in FIG. 17a. During the 0~t1 period, the SHB is in full-bridge operation mode; As shown in FIG. 17b, during the t1~t2 period, the adjustable duty cycle Da gradually decreases, while the reference duty cycle Db remains basically unchanged. The output voltage gradually decreases, and as indicated by the three turn-on time points A, B, and C in FIG. 17b, all switches maintain ZVS operation. As shown in FIG. 17c, during the t3~t4 period, the adjustable duty cycle Da decreases to 0 (at a relatively fast rate), and the output voltage continues to decrease. The module does not output work, and the resonant cavity current coincides with the excitation current, satisfying the ZVS condition. As shown in FIG. 17d, when t>t3, the SHB operates in an alternating half-bridge mode, and the output voltage decreases to 0.5 times.

From the results, during the full-bridge to half-bridge switching process in the embodiment of the present disclosure, the output voltage continuously decreases, the control process and system transient modes smoothly transition, and ZVS is maintained throughout the entire process for all switches.

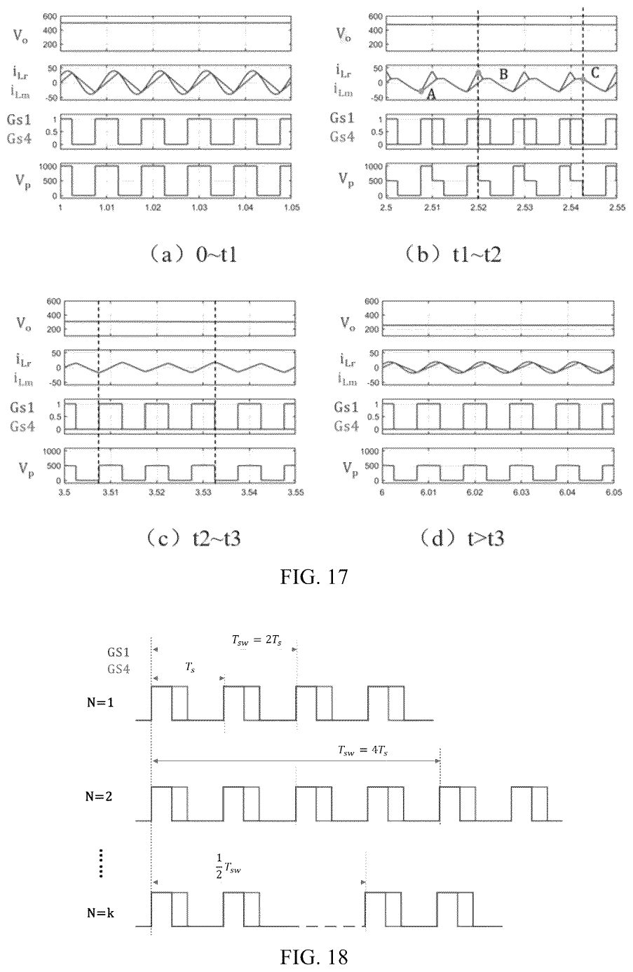

In some embodiments, based on the control frequency or other actual conditions, the adjustable duty cycle can be alternated once every N switching cycles, with the alternating period being Tsw=2*N*Ts. An appropriate alternating period or not alternate at all can be chosen according to requirements such as the control frequency in the method, as shown in FIG. 18. In other words, in the present disclosure, the alternating operation can be performed at a fixed period, with the fixed period being N switching cycles, or can be performed without a fixed period, as long as alternating operation is performed. The period of the alternating operation does not have to be fixed. In some embodiments, in the full-bridge operation mode, when alternating at a fixed switching period, Gs1 can operate ahead of Gs4 for N switching cycles, followed by Gs4 operating for N switching cycles. When operating without a fixed switching period, Gs1 can operate ahead of Gs4 for m switching cycles, followed by Gs1 lagging behind Gs4 for n switching cycles, and the alternating periods before and after are not equal (m≠n). In some embodiments, in the half-bridge operation mode, the same alternating method can be used, with alternating half-bridge operation performed for a fixed N switching cycles, or when not alternating at a fixed period, the two bridge arms can alternately operate for m and n switching cycles (m≠n). When operating in reverse, the same alternating method may be used for the secondary bridge arm.

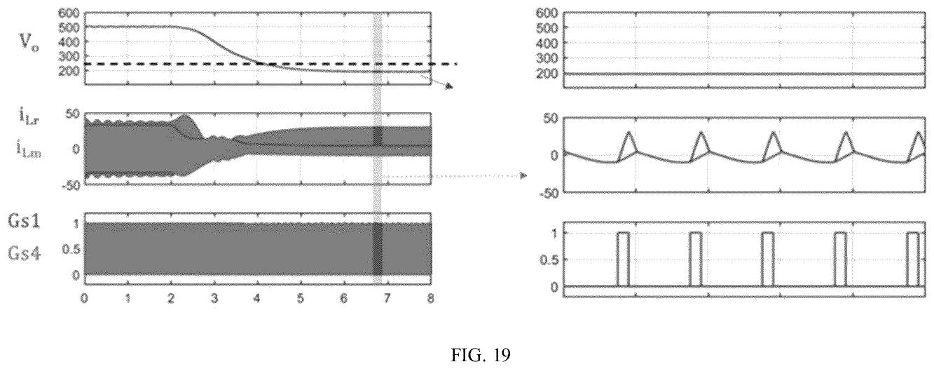

Based on the half-bridge operation, if the voltage is further required to reduce, the reference duty cycle Db can be reduced to achieve further voltage reduction, as shown in the simulation results in FIG. 19 (fs=fr). The output voltage (0.25≤Gain≤0.5) can further be reduced, and the voltage reduction process is smooth. Moreover, the alternating half-bridge operation ensures balanced power in the bridge arms and balanced Vdc capacitor voltage, maintaining ZVS.

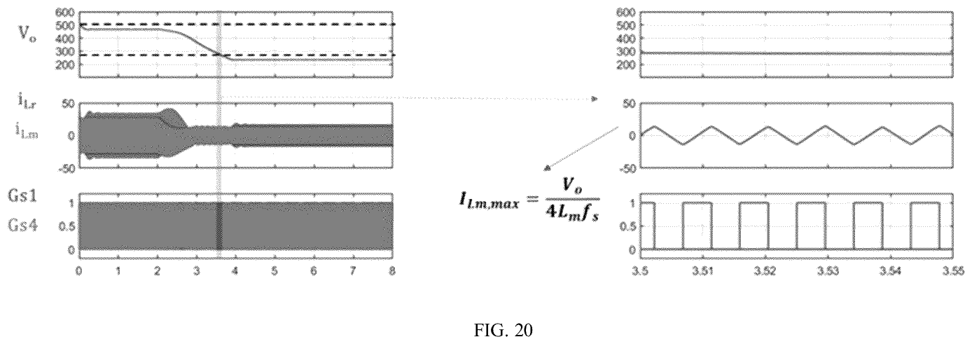

In the embodiments of the present disclosure, when in the full-bridge and half-bridge operation states, the switching frequency can also be adjusted, as shown in the simulation results in FIG. 20. The main advantage lies in regulating the output voltage, and since the turn-off current is related to the frequency, the system efficiency can be further improved by adjusting the frequency.

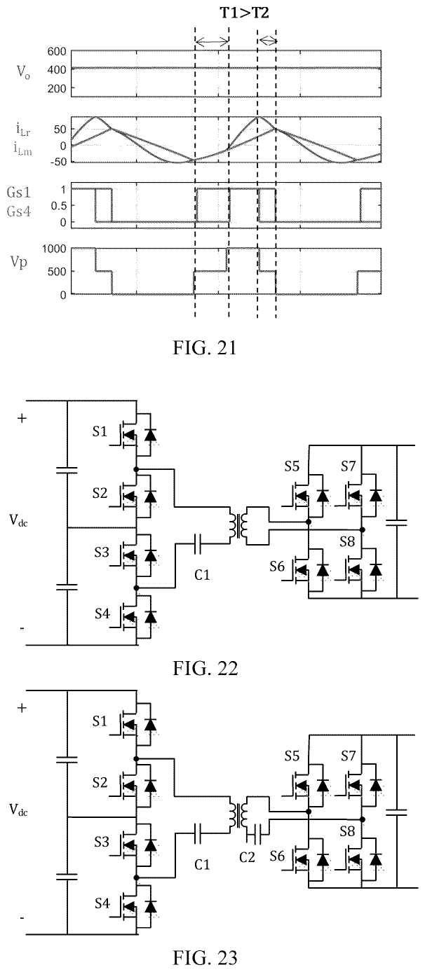

In some embodiments, the turn-on time difference T1 (T3) can also be less than the turn-off time difference T2 (T4). As shown in FIG. 21, the voltage can be reduced, and all switches can meet the ZVS condition when the turn-on time difference less than the turn-off time difference.

In some embodiments, the second circuit unit 40 is provided between the first end and the second end of the second side of the network unit 20. The corresponding circuit diagrams for the first circuit unit 10, the network unit 20, and the second circuit unit 40 can be as shown in FIG. 22, where the first circuit unit 10 and the network unit are the same as the first circuit unit 10 and the network unit in the previous FIG. 2. The second circuit unit 40 includes a third switch bridge arm and a fourth switch bridge arm; the third switch bridge arm includes the fifth switch S5 and the sixth switch S6 connected in series, and the fourth switch bridge arm includes the seventh switch S7 and the eighth switch S8 connected in series; the fifth switch S5 and the sixth switch S6 are electrically connected to form a third connection point; The seventh switch S7 and the eighth switch S8 are electrically connected to form a fourth connection point. The fifth switch S5 and the sixth switch S6 are complementary switches, and the seventh switch S7 and the eighth switch S8 are complementary switches. The first end of the second side of the network unit is electrically connected to the third connection point, and the second end of the second side of the network unit is electrically connected to the fourth connection point.

In some embodiments, as shown in FIG. 23, the network unit further includes a second capacitor C2. The first capacitor C1 is provided on the first side of the network unit, and the second capacitor C2 is provided on the second side of the network unit. The control unit is used to output a fifth control signal to the control terminal of the fifth switch and output an eighth control signal to the control terminal of the eighth switch. The time difference between the rising edge of the fifth control signal and the rising edge of the eighth control signal is T5, and the time difference between the falling edge of the fifth control signal and the falling edge of the eighth control signal is T6, where a following condition is satisfied: T5 T6, and T5 is greater than or equal to 0, and T6 is greater than or equal to 0.

In some embodiments, the fifth switch and the seventh switch are connected, and the sixth switch and the eighth switch are connected, so that the third switch bridge arm and the fourth switch bridge arm are connected in parallel; or, the sixth switch and the seventh switch are connected, so that the third switch bridge arm and the fourth switch bridge arm are connected in series.

In some embodiments, the control unit 30 controls a fifth operation mode and a sixth operation mode of the power conversion apparatus to alternate operation through the fifth control signal and the eighth control signal; wherein the fifth operation mode is the fifth control signal leading the eighth control signal, and the sixth operation mode is the fifth control signal lagging behind the eighth control signal. The alternate operation of the fifth operation mode and the sixth operation mode is similar to the alternate operation of the first operation mode and the second operation mode introduced earlier, and will not be elaborated here.

In some embodiments, the control unit 30 controls a seventh operation mode and a eighth operation mode of the power conversion apparatus to alternate operation through the fifth control signal and the eighth control signal; wherein the seventh operation mode is a duty cycle of the fifth control signal is 0 and a duty cycle of the eighth control signal is not 0, and a eighth operation mode is a duty cycle of the fifth control signal is not 0 and a duty cycle of the eighth control signal is 0. The alternate operation of the seventh operation mode and the eighth operation mode is similar to the alternate operation of the first operation mode and the second operation mode introduced earlier, and will not be elaborated here.

The embodiments of the present disclosure are applicable to full-bridge topologies. The circuit diagram can be as shown in FIG. 24. Reverse power transmission can be achieved. Accordingly, wide-range step-down, ZVS, and balanced power in the bridge arms all can be achieved through the method of the embodiments of the present disclosure.

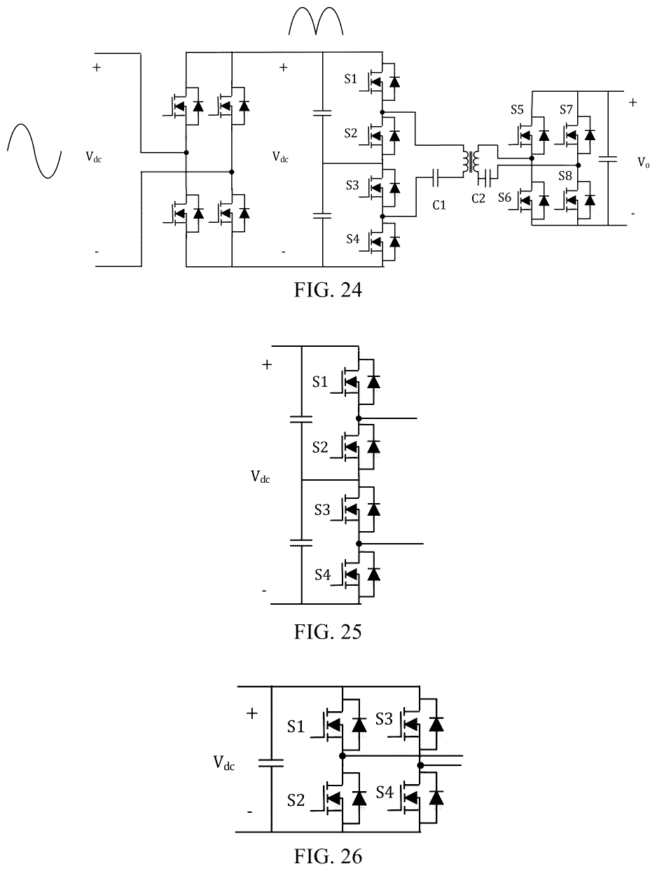

The following describes the alternative solutions of the circuits corresponding to the first circuit unit 10, the network unit 20, and the second circuit unit 40 in the power conversion apparatus shown in FIG. 1 and FIG. 4. The embodiments of the present disclosure may be applied to full-bridge and half-bridge topologies, and, the first circuit unit 10 can be a SHB or H bridge, as shown in FIG. 25 and FIG. 26.

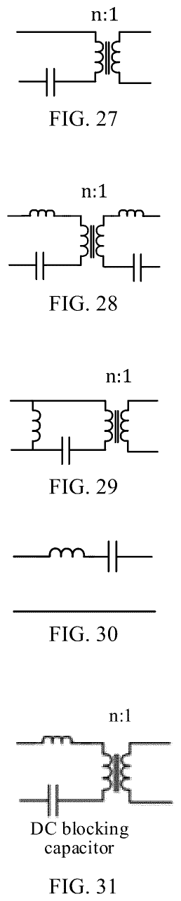

The network unit 20 may be an LLC circuit, CLLC circuit, LLCL circuit, non-isolated dual active bridge converter, or isolated dual active bridge converter. As some examples, the circuits can be as shown in FIGS. 27-31.

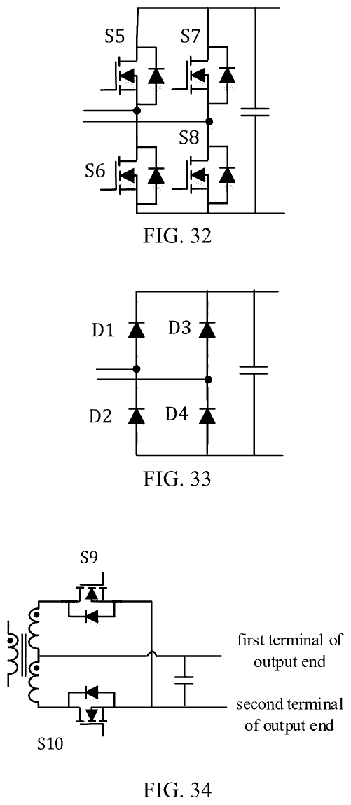

The second circuit unit 40 may be a synchronous rectifier circuit, an uncontrolled rectifier circuit, or a full-wave rectifier circuit. As some examples, the circuits can be as shown in FIGS. 32-34.

As shown in FIG. 33, the second circuit unit 40 includes a first diode D1, a second diode D2, a third diode D3, and a fourth diode D4. The first diode D1 and the second diode D2 are connected in series, and the third diode D3 and the fourth diode D4 are connected in series. The branch having the first diode and the second diode is connected in parallel with a branch having the third diode and the fourth diode.

The first diode D1 and the second diode D2 are electrically connected to form a fifth connection point; the third diode D3 and the fourth diode D4 are electrically connected to form a sixth connection point; the first end of the second side of the network unit 20 is electrically connected to the fifth connection point, and the second end of the second side of the network unit 20 is electrically connected to the sixth connection point.

The network unit includes a transformer, as shown in FIG. 34, the second circuit unit 40 includes the ninth switch S9 and the tenth switch S10. The secondary side of the transformer includes a first winding and a second winding, the first winding and the second winding are electrically connected to form a seventh connection point, and the seventh connection point is connected to the first end of the output terminal.

The first end of the ninth switch S9 is connected to the end of the first winding away from the seventh connection point. The first end of the tenth switch S10 is connected to the end of the second winding away from the seventh connection point. The second end of the ninth switch S9 and the second end of the tenth switch S10 are connected to the second end of the output terminal.

It should be noted that, based on the above examples, a person skilled in the art can freely combine them according to actual needs.

In the embodiments of the present disclosure, the terms “first”, “second”, and “third” are only used for descriptive purposes and should not be understood as indicating or implying relative importance.

The terms “first”, “second” and the like mentioned in the present disclosure are only used to distinguish different apparatuses, modules or units, and are not used to limit the sequence or interdependence of the functions performed by these apparatuses, modules or units.

The term “and/or” in the present disclosure merely describes the association relationship between associated objects and indicates that three relationships can exit, for example, “A and/or B” can represent: only A exists, both A and B exist, and only B exists. Additionally, the character “/” in this document generally indicates that the associated objects before and after it have an “or” relationship.

It should be noted that although several modules or units for performing actions are mentioned in the detailed description above, such division is not mandatory.

In fact, according to the implementation methods of the present disclosure, the features and functions of two or more modules or units described above can be embodied in one module or unit. Conversely, the features and functions of one module or unit described above can be further divided and embodied by multiple modules or units.

Some block diagrams shown in the attached drawings are functional entities and do not necessarily correspond to physically or logically independent entities. The functional entities can be implemented in software form, or in one or more hardware modules or integrated circuits, or in different network and/or processor apparatuses and/or microcontroller apparatuses.

Based on the same inventive concept, a method for controlling a power conversion apparatus is provided. The control method may be applied to the power conversion apparatus above. The method including: outputting the first control signal to the control terminal of the first switch, and outputting the fourth control signal to the control terminal of the fourth switch; where the time difference between the rising edge of the first control signal and the rising edge of the fourth control signal is T1, and the time difference between the falling edge of the first control signal and the falling edge of the fourth control signal is T2, and a following condition is satisfied: T1 #T2, and T1 is greater than or equal to 0.

In some embodiments, the method further including: outputting a second control signal to a control terminal of the second switch, and outputting a third control signal to a control terminal of the third switch; where a time difference between a rising edge of the second control signal and a rising edge of the third control signal is T3, and a time difference between a falling edge of the second control signal and a falling edge of the third control signal is T4, and a following condition is satisfied: T3≠T4, and T3 is greater than or equal to 0.

The embodiments described above are merely some of the embodiments of the present disclosure, not all embodiments. The components of the embodiments of the present disclosure described and shown in the previous figures can be provided and designed in various different configurations. Therefore, the detailed description of the embodiments of the present disclosure provided in the figures is not intended to limit the scope of the present disclosure, but merely represents selected embodiments of the present disclosure. All other embodiments obtained by a person skilled in the art without making creative efforts based on the embodiments of the present disclosure fall within the scope of protection of the present disclosure.

The present disclosure aims to cover any variations, uses, or adaptations of the present disclosure that follow the general principles of the present disclosure and include common knowledge or conventional techniques in the technical field of the present disclosure that are not disclosed herein. The description and embodiments are merely exemplary, and the true scope and spirit of the present disclosure are indicated by the appended claims.

What is claimed is:

1. A power conversion apparatus, comprising:
a first circuit, comprising a first switch bridge arm and a second switch bridge arm, wherein the first switch bridge arm comprises a first switch and a second switch connected in series, and the second switch bridge arm comprises a third switch and a fourth switch connected in series; the first switch and the second switch are electrically connected to form a first connection point; the third switch and the fourth switch are electrically connected to form a second connection point, the first switch and the second switch are complementary switches, and the third switch and the fourth switch are complementary switches;
a network circuit, comprising at least a first capacitor, wherein a first end of a first side of the network circuit is electrically connected to the first connection point, and a second end of the first side of the network circuit is electrically connected to the second connection point; and
a controller, connected to the first switch bridge arm and the second switch bridge arm, wherein the controller is configured to output a first control signal to a control terminal of the first switch, and output a fourth control signal to a control terminal of the fourth switch;
wherein, a time difference between a rising edge of the first control signal and a rising edge of the fourth control signal is T1, a time difference between a falling edge of the first control signal and a falling edge of the fourth control signal is T2, wherein a following condition is satisfied: T1≠T2, T1 is greater than or equal to 0, and T2 is greater than or equal to 0.

2. The power conversion apparatus according to claim 1, wherein, the controller is further configured to output a second control signal to a control terminal of the second switch, and output a third control signal to a control terminal of the third switch.

3. The power conversion apparatus according to claim 2, wherein, the first switch bridge arm and the second switch bridge arm are connected in series or in parallel;
the first switch and the third switch are connected, and the second switch and the fourth switch are connected, causing the first switch bridge arm and the second switch bridge arm to be connected in parallel; or, the second switch and the third switch are connected, causing the first switch bridge arm and the second switch bridge arm to be connected in series.

4. The power conversion apparatus according to claim 1, wherein, the time difference T1 between the rising edge of the first control signal and the rising edge of the fourth control signal satisfies a following condition:
(1/4−Da₁)Ts₁<T1<Ts₁/4
Ts₁ represents a switching period of the first control signal, and Da₁ represents an adjustable duty cycle of the first control signal.

5. The power conversion apparatus according to claim 1, wherein, the controller is further configured to perform gain adjustment over a wide range by regulating the time difference T2 between the falling edge of the first control signal and the falling edge of the fourth control signal.

6. The power conversion apparatus according to claim 2, wherein, the controller is further configured to perform gain adjustment over a wide range by regulating a time difference T4 between a falling edge of the second control signal and a falling edge of the third control signal.

7. The power conversion apparatus according to claim 1, wherein, the power conversion apparatus further comprises:
a second circuit, provided between a first end and a second end of a second side of the network circuit;
wherein the second circuit is one of a synchronous rectifier circuit, an uncontrolled rectifier circuit, or a full-wave rectifier circuit.

8. The power conversion apparatus according to claim 1, wherein, the power conversion apparatus further comprises:
a second circuit, comprising a third switch bridge arm and a fourth switch bridge arm; wherein the third switch bridge arm comprises a fifth switch and a sixth switch connected in series, and the fourth switch bridge arm comprises a seventh switch and an eighth switch connected in series; the fifth switch and the sixth switch are electrically connected to form a third connection point; the seventh switch and the eighth switch are electrically connected to form a fourth connection point, the fifth switch and the sixth switch are complementary switches, and the seventh switch and the eighth switch are complementary switches;
a first end of a second side of the network circuit is electrically connected to the third connection point, and a second end of the second side of the network circuit is electrically connected to the fourth connection point.

9. The power conversion apparatus according to claim 1, wherein, the power conversion apparatus further comprises:
a second circuit, comprising a first diode, a second diode, a third diode and a fourth diode;
wherein the first diode and the second diode are connected in series, and the third diode and the fourth diode are connected in series; a branch having the first diode and the second diode is connected in parallel with a branch having the third diode and the fourth diode;
the first diode and the second diode are electrically connected to form a fifth connection point; the third diode and the fourth diode are electrically connected to form a sixth connection point; and a first end of a second side of the network circuit is electrically connected to the fifth connection point, and a second end of the second side of the network circuit is electrically connected to the sixth connection point.

10. The power conversion apparatus according to claim 1, wherein, the network circuit comprises a transformer;
the power conversion apparatus further comprises a second circuit; the second circuit comprises a ninth switch and a tenth switch;
a secondary side of the transformer comprises a first winding and a second winding, the first winding and the second winding are electrically connected to form a seventh connection point, and the seventh connection point is connected to a first end of an output terminal;
a first end of the ninth switch is connected to an end of the first winding away from the seventh connection point; a first end of the tenth switch is connected to an end of the second winding away from the seventh connection point; and a second end of the ninth switch and a second end of the tenth switch are connected to a second end of the output terminal.

11. The power conversion apparatus according to claim 8, wherein, the network circuit further comprises a second capacitor; the first capacitor is provided on the first side of the network circuit, and the second capacitor is provided on the second side of the network circuit;
the controller is configured to output a fifth control signal to a control terminal of the fifth switch and output an eighth control signal to a control terminal of the eighth switch;
wherein, a time difference between a rising edge of the fifth control signal and a rising edge of the eighth control signal is T5, a time difference between a falling edge of the fifth control signal and a falling edge of the eighth control signal is T6, and a following condition is satisfied: T5≠T6, T5 is greater than or equal to 0, and T6 is greater than or equal to 0.

12. The power conversion apparatus according to claim 11, wherein, the fifth switch and the seventh switch are connected, and the sixth switch and the eighth switch are connected, causing the third switch bridge arm and the fourth switch bridge arm to be connected in parallel;
or, the sixth switch is connected to the seventh switch, causing the third switch bridge arm and the fourth switch bridge arm to be connected in series.

13. The power conversion apparatus according to claim 1, wherein, the power conversion apparatus is an inductor-inductor-capacitor (LLC) circuit, a capacitor-inductor-inductor-capacitor (CLLC) circuit, an inductor-inductor-capacitor-inductor (LLCL) circuit, a non-isolated dual active bridge converter or an isolated dual active bridge converter.

14. The power conversion apparatus according to claim 1, wherein, the controller further comprises:
an enable control circuit, outputting an enable control signal to a duty cycle control circuit;
wherein the controller switches the first circuit from a full-bridge working state to a half-bridge working state based on the enable control signal.

15. The power conversion apparatus according to claim 1, wherein, the controller controls alternate operation between a first operation mode and a second operation mode of the power conversion apparatus through the first control signal and the fourth control signal; wherein the first control signal leads the fourth control signal in the first operation mode, and the first control signal lags the fourth control signal in the second operation mode.

16. The power conversion apparatus according to claim 14, wherein, the controller controls alternate operation between a third operation mode and a fourth operation mode of the power conversion apparatus through the first control signal and the fourth control signal; wherein the third operation mode is a duty cycle of the first control signal is 0 and a duty cycle of the fourth control signal is not 0, and the fourth operation mode is a duty cycle of the first control signal is not 0 and a duty cycle of the fourth control signal is 0.

17. The power conversion apparatus according to claim 11, wherein, the controller controls a fifth operation mode and a sixth operation mode of the power conversion apparatus to alternate operation through the fifth control signal and the eighth control signal; wherein the fifth operation mode is the fifth control signal leading the eighth control signal, and the sixth operation mode is the fifth control signal lagging behind the eighth control signal.

18. The power conversion apparatus according to claim 11, wherein, the controller controls a seventh operation mode and a eighth operation mode of the power conversion apparatus to alternate operation through the fifth control signal and the eighth control signal; wherein the seventh operation mode is a duty cycle of the fifth control signal is 0 and a duty cycle of the eighth control signal is not 0, and a eighth operation mode is a duty cycle of the fifth control signal is not 0 and a duty cycle of the eighth control signal is 0.

19. The power conversion apparatus according to claim 1, wherein, the controller further comprises:
a switch frequency control circuit, configured to generate a switch frequency signal;
wherein the controller generates the first control signal and the fourth control signal based on the switch frequency signal;
the controller further regulate a gain of the power conversion apparatus by adjusting the switch frequency signal.

20. A method for controlling the power conversion apparatus according to claim 1, comprising:
outputting the first control signal to the control terminal of the first switch, and outputting the fourth control signal to the control terminal of the fourth switch;
wherein the time difference between the rising edge of the first control signal and the rising edge of the fourth control signal is T1, and the time difference between the falling edge of the first control signal and the falling edge of the fourth control signal is T2, and a following condition is satisfied: T1≠T2, and T1 is greater than or equal to 0.
